(19) United States
(12) Patent Application Publication
(10) Pub. No.: US 2004/0250600 A1
(43) Pub. Date: Dec. 16, 2004

(54) Method of mass flow control flow verification and calibration

(76) Inventors: William Daniel Bevers, Orlando, FL (US); Joseph William Buckfeller, Orlando, FL (US); James L. Flack, Oviedo, FL (US); Robert Francis Jones, Clermont, FL (US); Bennett J. Ross, Merritt Island, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/844,590

(22) Filed: May 12, 2004

Related U.S. Application Data
(60) Provisional application No. 60/469,669, filed on May 12, 2003.

(51) Int. Cl. G01N 29/02

(52) U.S. Cl. 73/1.16

(57) ABSTRACT

A method and apparatus for monitoring or calibrating a gas flow rate through a mass flow controller, for example, in a semiconductor fabrication process. A reference mass flow controller is disposed in a vent bypass loop for receiving gas flow from one of a plurality of mass flow controllers associated with a like plurality of supply gases. One of the gas supply mass flow controllers is selected and commanded to a specific gas flow rate. The gas flow through the selected mass flow controller also passes through the reference mass flow controller as the gas flows to a vent. Comparing the gas supply mass flow controller commanded flow rate with the actual flow rate as determined by the reference mass flow controller provides monitoring and calibration of the gas supply mass flow controller.

This application claims the benefit, under 35 U.S.C. 119(e), of the provisional patent application filed on May 12, 2003 and assigned application No. 60/469,669.

### FIELD OF THE INVENTION

This invention relates generally to fabrication of semiconductor integrated circuits, and more particularly to a method and apparatus for verification and calibration of a mass flow controller through which a gas is supplied to a process chamber used during integrated circuit fabrication.

### BACKGROUND OF THE INVENTION

Integrated circuits (or chips) comprise a silicon substrate having semiconductor devices, such as transistors, formed from doped regions within the substrate. Conductive interconnect structures, formed in a plurality of parallel layers overlying the semiconductor substrate, electrically connect the semiconductor devices to form electrical circuits within the integrated circuit.

Fabrication of the integrated circuit begins with a silicon wafer that is subjected to a plurality of sequential fabrication processes to form multiple identical chips in the wafer, each chip comprising active devices (e.g., transistors) and passive devices (e.g., capacitors and resistors) that cooperate to provide a desired functionality.

Several different sequential processes are executed to form and interconnect the devices. Generally, the processes include, but are not limited to: implanting and diffusing dopant impurities; depositing elements on an upper surface of the substrate by physical and chemical vapor deposition; masking, patterning, and etching conductive and dielectric structures; and growing dielectric and semiconductor materials from the upper surface.

Each process is performed in a process chamber (also referred to as a process tool) enclosing one or more wafers. At the conclusion of the process, the wafer is removed from a current chamber and transferred to another chamber where the next process is executed. Each process comprises a plurality of process steps that are automatically initiated and controlled by a process controller. During certain process steps, various gases and materials are introduced into the chamber, while chamber temperature and pressure are carefully controlled. The duration of each step, the quantity and timing of gases and materials supplied to the chamber, and the chamber temperature and pressure are specified in a process recipe that is input to the process controller for effectuating control over each process step.

FIG. 1 illustrates a process chamber 10 for receiving one or more of a plurality of gas species from gas supplies 1, 2, 3 and 4. As is known to those skilled in the art, the number of gas supplies indicated in FIG. 1 is merely exemplary. Depending on the process carried out in the process chamber 10, more or fewer gas supplies may be required. For example, in a process chamber where germanium is selectively deposited on silicon, the gases can include, dichlorosilane (SiH₂Cl₂), hydrogen (H₂), diborane (B₂H₆), hydrochloric acid (HCl) and germane (GeH₄).

Gas is supplied from each of the gas supplies 1, 2, 3 and 4 to a fluid node 19 through a serial configuration of a mass flow controller 12, 14, 16 and 18 and a pneumatic valve 22, 24, 26 and 28, respectively. The mass flow controllers 12, 14, 16 and 18 regulate the flow of species gases into the process chamber 10. Accurate process control requires that the gas flow be carefully regulated, as failure to do so may result in the fabrication of defective integrated circuits. To ensure accurate gas flow the calibration of each mass flow controller is checked on a regular basis.

As further illustrated in FIG. 1, a pneumatic valve 30 is disposed in the process line 20 between the fluid node 19 and the process chamber 10.

A programmable system controller 40 controls the pneumatic valves 22, 24, 26, 28 and 30, opening or closing the valves in accordance with requirements for gas flow into the process chamber 10 during a specific process step. Further, the system controller 40 supplies a set point value to each of the mass flow controllers 12, 14, 16 and 18 to establish the gas flow rate in accordance with the recipe for each process step. The gas flow rates are typically measured in sccm (cubic centimeters per minute at standard temperature and pressure) or slm Liters per minute at standard temperature and pressure).

FIG. 1 also illustrates a vent line 46 and a pneumatic vent valve 48 in serial fluid communication with the fluid node 19 for venting a species gas to exhaust and abatement in when a vent valve 48 is open.

It is known that when the system controller 40 sets a mass flow controller flow rate, a finite transient interval is required for the gas flow to reach the new flow rate. To prevent introducing gas at an incorrect flow rate into the process chamber 10, during this transient interval the gas supply is vented to the vent line 46 via the vent valve 48. After the transient interval, as indicated by a relatively flat or constant flow rate, the vent valve 48 is closed, the process line valve 30 is opened, and the gas flows to the process chamber 10.

Each mass flow controller is calibrated for a specific gas species and once installed, it may be difficult to determine if the mass flow controller is supplying gas at the commanded or desired flow rate for the process step. According to one prior art technique for verifying the gas flow rate, the mass flow controller is removed and replaced with a mass flow controller that is known to supply gas at the commanded flow rate. This is a time-consuming and labor intensive process as the fluid lines must be purged and the process chamber 10 may have to be cleaned, if the chamber integrity is violated, before and after replacement of the mass flow controller.

According to another verification technique, the actual gas flow rate through the mass flow controller is determined from the rate at which the process chamber fills with gas. After evacuating the process chamber 10, gas flow from the mass flow controller under test is introduced into the process chamber 10 through the process line 20. Since the chamber volume is known, it is possible to calculate the flow rate into the chamber from the ideal gas law, PV=nRT. The chamber temperature and volume are known, and the constant R is known. Gas is supplied to the chamber 10 until the chamber pressure equals the gas supply pressure, at which time the gas flow ends. Using these parameters, the number of moles of gas can be determined from the ideal gas law equation. Since the time duration to fill the chamber is measured, the flow rate is determined from the number of moles divided by the time required to fill the chamber.

It is known that this so-called “rate of rise” measurement technique is prone to error. For example, the chamber volume may not be known precisely due to non-uniformity in the chamber walls. Also, it may not be possible to hold the chamber temperature constant or determine the chamber temperature.

It is known that certain gas species are reactive to chamber components and thus the components can be damaged by exposure to these gases. During regular chamber operation these gases are supplied to the chamber only when accompanied by a neutralizing gas that reacts with the damage-causing gas to prevent chamber component damage. In such process systems it is not advisable to use the rate of rise technique to determine flow rate accuracy.

To determine flow rate for these chambers, multiple gas flows are introduced to the process chamber, during which time a unique film is formed on a wafer disposed in the chamber. Certain gas flow rates can be determined from measured characteristics of the film.

### BRIEF SUMMARY OF THE INVENTION

The present invention comprises a method for monitoring or calibrating gas flows in a system with multiple process gases prior to entry into a process chamber. The method comprises flowing each of several gases through a different mass flow controller prior to entry into the process chamber, and diverting gas flow to a reference mass flow controller to correlate flow rate determinations between the reference mass flow controller and the mass flow controller specific to said gas.

The present invention further comprises an apparatus for monitoring or calibrating gas flows into a process chamber. The apparatus comprises multiple supply gases and multiple supply gas mass flow controllers, wherein each supply gas is associated with a supply gas mass flow controller for controlling the flow rate of the supply gas therethrough. One or more of the supply gases flows into the process chamber through a first fluid path. A reference mass flow controller is disposed in a second fluid path, wherein at least one of the supply gases is made to flow through the reference mass flow controller to correlate flow rate determinations between the reference mass flow controller and the supply gas mass flow controller associated with the supply gas.

### BRIEF DESCRIPTION OF THE DRAWINGS

The foregoing and other features of the present invention will be apparent from the following more particular description of the invention as illustrated in the accompanying drawings, in which like reference characters refer to the same parts throughout the different figures. The drawings are not necessarily to scale, emphasis instead being placed upon illustrating the principles of the invention.

FIG. 1 is a schematic diagram of a prior art chamber process configuration.

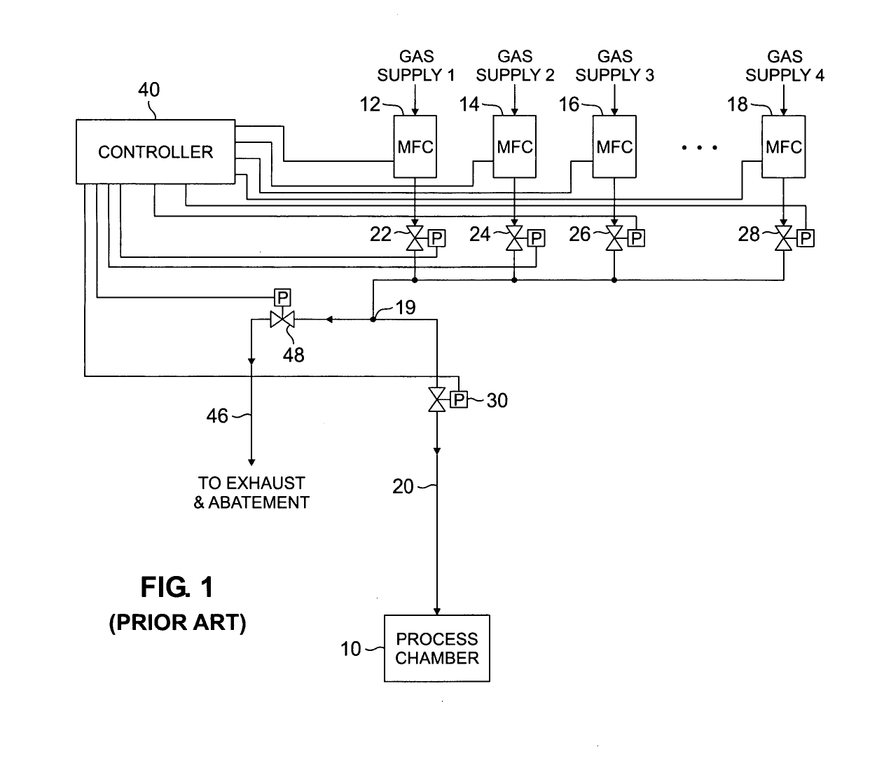

FIG. 2 is a schematic diagram of a chamber process configuration according to the teachings of the present invention.

### DETAILED DESCRIPTION OF THE INVENTION

Before describing in detail the particular semiconductor integrated circuit process method and apparatus according to the present invention, it should be observed that the present invention resides in a novel and non-obvious combination of hardware elements and process steps. Accordingly, these elements have been represented by conventional elements in the drawings and specification, wherein elements and process steps conventionally known in the art are described in lesser detail, and elements and steps pertinent to understanding the invention are described in greater detail.

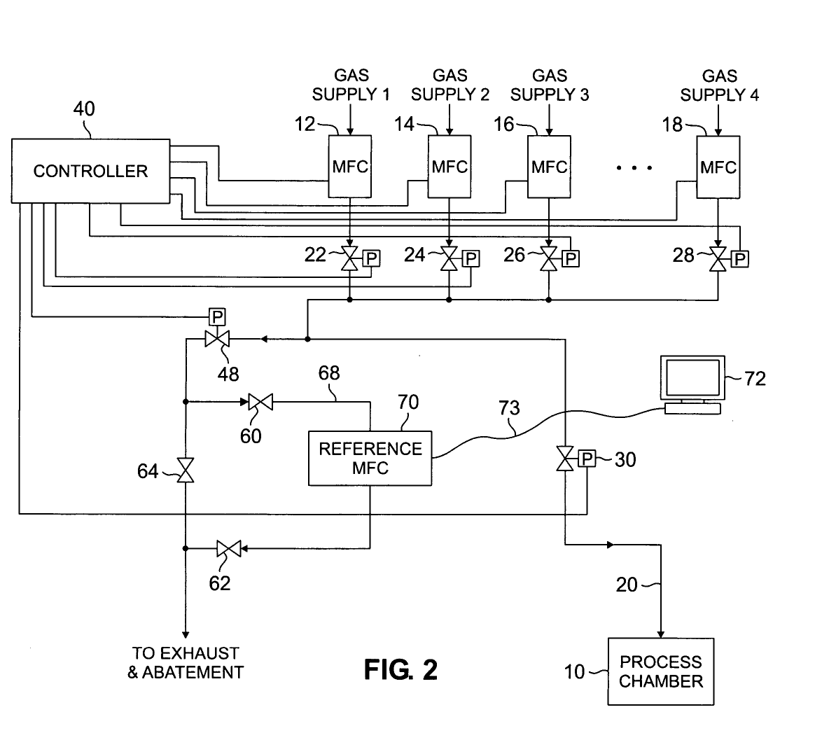

As illustrated in FIG. 2, a process tool configuration for flow rate calibration or verification according to the present invention comprises valves 60, 62 and 64 disposed within the vent line 46 to form a bypass loop 68. The valve 60 is disposed in a fluid entry path of the bypass loop 68, and the valve 62 is disposed in a fluid exit path of the bypass loop 68. In a preferred embodiment, each of the valves 60, 62 and 64 comprises a manual valve. In another embodiment, the valves 60, 62 and 64 can be commanded open by the system controller 40 (via a conductor not shown in FIG. 2) prior to initiating a flow verification or calibration process according to the present invention. In yet another embodiment, other valving arrangements can be employed to permit fluid flow through the reference mass flow controller 70 when it is desired to monitor or calibrate a supply gas flow, and to permit supply gas flow to the process chamber during process execution. For example, one or more of the valves 48, 60, 62 and 64 can be combined into a single valve to control the fluid flow as desired.

The bypass loop 68 further comprises a reference mass flow controller 70 for determining a flow rate therethrough. The reference mass flow controller 70 receives information from and supplies information to a computer or programmable controller 72 over a bidirectional electrical link 73. In a preferred embodiment, the mass flow controller 70 comprises a digital mass flow controller as it is known that digital mass flow controllers tend to be more accurate than analog versions. In another embodiment, the mass flow controller 70 comprises an analog mass flow controller.

To perform a verification or calibration of one of the mass flow controllers 12, 14, 16 or 18 according to the teachings of the present invention, the valve 64 is closed and the valves 60 and 62 are opened. Also, the vent valve 48 is opened and the process line valve 30 is closed. These valve settings permit a gas species from one of the gas supplies 1, 2, 3 and 4 to flow through its respective mass flow controller and the bypass loop 68.

Assuming that the mass flow controller 12 is selected for verification or calibration, the system controller 40 commands the mass flow controller 12 to a gas flow rate. The gas flows from the gas supply 1, serially through the mass flow controller 12 and the bypass loop 68, including the reference mass flow controller 70. The computer 72 stores the flow rate as measured by the reference mass flow controller 70, i.e., a reference flow rate.

The reference flow rate can be recorded in the computer 72 and/or supplied as an input to the system controller 40 for use in calculating a correction factor for the mass flow controller 70, representing the difference between the commanded flow rate for the mass flow controller 12 and the reference flow rate as measured by the reference mass flow controller 70. When the mass flow controller 12 is operative during a process step, the system controller 40 uses the correction factor to calculate a corrected gas flow rate from the desired gas flow rate. The system controller 40 commands the mass flow controller 12 to the corrected gas flow rate to ensure that the actual flow rate therethrough equals the desired flow rate. Using this technique, the remaining mass flow controllers 14, 16 and 18 can also be calibrated.

The reference flow rate (or the correction factor) also represents a base line flow rate for the mass flow controller 12. At a later time, the mass flow controller 12 undergoes another verification/calibration process as described above for the same gas species. Any difference between the base line flow rate and a later-determined reference flow rate indicates a change in the flow rate control mechanism of the mass flow controller 12.

Advantageously, the apparatus and method according to the present invention is self-checking for a fault in the reference mass flow controller 70. During a routine verification of gas flow rates using the reference mass flow controller 70, if all flow rates deviate from a previously determined base line flow rate, improper operation of the reference mass flow controller is indicated.

As is known in the art, it is advantageous to calibrate a mass flow controller to a specific gas species, since the flow rate control mechanism of the mass flow controller is based on certain characteristics of the gas species (e.g., molecular size and gas temperature). In an embodiment where the reference mass flow controller 70 is not calibrated to a specific gas species, a series of calibration tests can be conducted to determine a correlation between the reference flow rate determined by the reference mass flow controller 70 and the actual flow rate for a given gas species. Once the correlation factor is known, a mathematical algorithm can be used to calculate the actual gas flow rate from the reference flow rate for a gas species.

It is expected that the reference mass flow controller would be calibrated for a “generic” gas, such as nitrogen. It is advantageous that the reference mass flow controller 70 be correctly sized to recognize flow deviations of about 5% or less. That is if a flow rate of 100 sccm is desired, then the reference mass flow controller should be capable of providing flow rates from bout 95 sccm (95%) to about 105 sccm (105%).

Using the procedure set forth below, the reference mass flow controller can be calibrated for any gas species. Correlation curves and calibration factors generated for specific gas species permit conversion of the reference mass flow controller flow reading to an actual gas flow rate for any species. A correlation curve allows determination of the actual flow rate for a specific gas from the flow rate measured by the reference mass flow controller 70. For example, if the reference mass flow controller indicates a flow rate of 40 sccm of gas A, a correlation curve can be used to determine that gas A is actually flowing at 50 sccm. From the correlation curve, the offset between the reference mass flow controller reading and the actual gas flow is 1.25 times the reference value (50/40=1.5). The calibration factor is thus 1.25. If the reference mass flow controller 70 later measures a flow rate of 80 sccm for gas A, the computer 72 uses the 1.25 calibration factor to determine the actual flow rate of 100 sccm (80×1.25=100).

One method for determining the correlation curves for each gas species is described below. It is assumed that the selected mass flow controller, such as the mass flow controller 12, and the reference mass flow controller 70 are known good mass flow controllers. A flow rate for a gas of interest, (i.e., the gas from gas supply 1 since the mass flow controller 12 was selected) is identified, for example a flow rate of 100 sccm. A flow rate range, between a low flow rate and a high flow rate, is selected to ensure an adequate margin above and below the flow rate of interest. For example, a margin of +/−50% is generally considered adequate. A flow rate increment, i.e., the amount by which the flow rate will be changed during each test trial is selected. The chosen increment should be less than the maximum gas flow deviation that the fabrication process can tolerate, for example, 5% or 5 sccm of the target flow.

The selected mass flow controller is commanded to the low flow rate and incrementally increased, at the incremental rate, to the high flow rate. For example, in the present example, flow rates of 50, 55, 60, 65 . . . 140, 145 and 150 are used. For each of these flow rates, a reference flow rate is determined by the reference mass flow controller 70. A correlation curve is created by plotting the commanded gas flow values on the x-axis versus the reference flow rates on the y-axis. An equation of the curve can also be determined and used as the correlation equation or calibration factor for the selected gas species. Future flow rate values determined by the reference mass flow controller 70 can be used in the correlation equation to determine the actual gas flow rate as measured by the reference mass flow controller 70 for a given gas species. The procedure is executed for each gas species in the process system to generate a correlation curve for each species.

While the present invention has been described with reference to preferred embodiments, it will be understood by those skilled in the art that various changes may be made and equivalent elements may be substituted for the elements thereof without departing from the scope of the present invention. The scope of the present invention further includes any combination of the elements from the various embodiments set forth herein. In addition, modifications may be made to adapt a particular situation to the teachings of the present invention without departing from its essential scope. For example, the teachings of the present invention are not limited to the use of mass flow controllers in the semiconductor fabrication industry, but can also be applied to mass flow controllers in the food and pharmaceutical industries. Therefore, it is intended that the invention not be limited to the particular embodiments disclosed, but that the invention will include all embodiments falling within the scope of the appended claims.

What is claimed is:

1. A method for monitoring or calibrating gas flows in a system with multiple process gases prior to entry into a process chamber, comprising:
a) flowing each of several gases through a different mass flow controller prior to entry into the process chamber; and
b) diverting gas flow to a reference mass flow controller to correlate flow rate determinations between the reference mass flow controller and the mass flow controller specific to said gas.

2. The method of claim 1 further comprising determining a calibration factor in response to the flow rate determinations between the reference mass flow controller and the mass flow controller specific to said gas.

3. The method of claim 3 further comprising supplying the calibration factor as an input to the mass flow controller specific to said gas for adjusting the flow rate thereof according to the calibration factor.

4. The method of claim 1 wherein the step of diverting further comprises configuring a gas flow path permitting gas flow through the reference mass flow controller and preventing gas flow to the process chamber.

5. The method of claim 4 wherein the step of configuring the gas flow path further comprises configuring one or more flow control valves to permit gas flow through the reference mass flow controller and to prevent gas flow to the process chamber.

6. The method of claim 4 wherein the step of configuring a gas flow path further comprises flowing the gas to a vent flow path comprising the reference mass flow controller.

7. A method for determining a calibration factor for a reference mass flow controller for a specific process gas species in a system including multiple process gas species, wherein each one of the multiple process gas species operates in conjunction with an associated process gas mass flow controller, comprising:
a) flowing a specific gas species through the associated process gas mass flow controller at a plurality of gas flow rates;
b) determining a reference flow rate from the reference mass flow controller for each one of the plurality of gas flow rates; and
c) determining the calibration factor for the specific process gas species based on a relationship between the reference flow rate and the gas flow rate.

8. An apparatus for monitoring or calibrating gas flows into a process chamber, comprising:
multiple supply gases;
multiple supply gas mass flow controllers, wherein each supply gas is associated with a supply gas mass flow controller for controlling the flow rate of the supply gas therethrough;
a first and a second fluid path in selective fluid communication with the multiple supply gas mass flow controllers, wherein the process chamber is disposed in the first fluid path; and
a reference mass flow controller disposed in the second fluid path, wherein flow of a selected supply gas through the reference mass flow controller correlates flow rate determinations between the reference mass flow controller and the supply gas mass flow controller associated with the selected supply gas.

9. The apparatus of claim 8 wherein the second fluid path comprises a vent path and a bypass loop, and wherein the reference mass flow controller is disposed in the bypass loop.

10. The apparatus of claim 9 further comprising one or more valves having a first configuration for directing the selected supply gas through the second fluid path to the reference mass flow controller and a second configuration for directing the supply gas through the first fluid path to the process chamber.

11. The apparatus of claim 10 further comprising a system controller for commanding the one or more valves to the first or the second configuration.

12. The apparatus of claim 8 further comprising a system controller responsive to the flow rate determinations between the reference mass flow controller and the supply gas mass flow controller, and for controlling the supply gas mass flow controller in response thereto.

13. The apparatus of claim 8 wherein the second fluid path comprises a serial arrangement of a first valve, a second valve and a vent orifice, an entry fluid path branching from the second fluid path between the first and the second valves, an exit fluid path branching from the second fluid path between the second valve and the vent orifice, and further comprising a third valve serially disposed in the entry fluid path and a fourth valve serially disposed in the exit fluid path, wherein the reference mass flow controller is disposed between the third and the fourth valves.

14. The apparatus of claim 13 wherein for monitoring or calibrating gas flows the first, third and fourth valves are in an opened position and the second valve is in a closed position.

15. An apparatus for use in fabricating semiconductor integrated circuits, comprising:
a process chamber;
a plurality of supply gases;
a like plurality of supply gas mass flow controllers, wherein one of the plurality of supply gases is associated with one of the plurality of supply gas mass flow controllers for controlling a gas flow rate therethrough;
a first and a second fluid path in selective fluid communication with the plurality of supply gas mass flow controllers, wherein the process chamber is disposed in the first fluid path;
a reference mass flow controller disposed in the second fluid path for determining a reference flow rate of a selected supply gas to correlate with a flow rate determined by the supply gas mass flow controller associated with the selected supply gas.

16. The apparatus of claim 15 wherein the second fluid path comprises a vent path and a bypass loop, wherein the reference mass flow controller is disposed in the bypass loop.

17. The apparatus of claim 16 wherein the second fluid path further comprises a vent valve for selectively permitting gas flow through the second fluid path and a bypass loop valve for selectively permitting gas flow through the bypass loop.

18. The apparatus of claim 15 further comprising a valve having a first configuration for directing gas flow to the first fluid path and a second configuration for directing gas flow to the second fluid path.

19. The apparatus of claim 15 further comprising a recording device for storing the reference flow rate.

20. The apparatus of claim 15 further comprising a processing device for correlating the reference flow rate and the flow rate determined by the supply gas mass flow controller associated with the selected supply gas.

21. The apparatus of claim 15 further comprising a system controller responsive to the reference flow rate and the flow rate determined by the supply gas mass flow controller associated with the selected supply gas for controlling the supply gas mass flow controller in response thereto.
